(19) United States
(12) Patent Application Publication
(10) Pub. No.: US 2008/0134584 A1
(43) Pub. Date: Jun. 12, 2008

(54) Sealing device for window and door openings with self-sealing pass-through opening

(76) Inventor: Thomas M. McGhee, Turlock, CA (US)

Correspondence Address: RONALD B. SEFRNA, P.O. BOX 567, TYLER, TX, 75710, US

(21) Appl. No.: 11/635,857

(22) Filed: Dec. 8, 2006

(51) Int. Cl. E06B 7/16; F16J 15/44

(52) U.S. Cl. 49/484.1; 277/355

(57) ABSTRACT

A sealing device for sliding window and door openings with a self-sealing pass-through opening for electrical cords and the like includes a body having a generally planar panel with a pass-through aperture formed therein, and a perimeter frame surrounding the panel, and a self-sealing pass-through seal assembly connected to the panel of the body around and over the aperture. The seal assembly includes a brush seal with a pair of brushes disposed in opposing relation with each having bristles extending toward and meeting each other, and a web seal, formed of a thin flexible membrane with a slit formed therein, overlying the brush seal. Several embodiments of the seal assembly are provided. The panel may be formed of a single transparent pane, of double transparent panes, of screen mesh, or a combination thereof. The body length may be fixed or adjustable.

### FIELD OF THE INVENTION

The present invention generally relates to sealing devices for closing openings and for sealing around objects, and in its preferred embodiments more specifically relates to devices for closing primarily window and/or door openings, providing an integral pass-through opening in the device for electrical cords and other objects, and sealing around objects extending through the pass-through opening.

### BACKGROUND OF THE INVENTION

It is not uncommon for a homeowner or other occupier of a building to need access to a utility, such as electrical power or water, either outside the building or inside the building in a location where a utility connection is not readily available. As a non-limiting example, a person occupying a home may wish to operate an electrical appliance outside the home in a location where no outside electrical outlet is available. As another example, a person may need access to a water supply inside a building in a location where a water connection is not readily available. The options available in the prior art for addressing this problem are limited, and each has disadvantages.

One option is to install a utility connection, such as an electrical outlet, on the exterior of the building. Such an installation may be costly, and the person occupying the home or other building may not be the owner of the building and may not have authority to install such an outlet. Another option, perhaps the most commonly used, is to route, e.g., an electrical cord from an outlet inside the building through an opened window or door. Although this practice does provide the desired utility access, it creates additional problems, including sealing the window or door against air exchange between the outside and inside of the building or the ingress of water. Further, an electrical cord may be damaged if a window or door is closed tightly against the cord, creating a safety risk. Leaving the window or door open can also pose a security risk.

There is a need for an inexpensive, easily installed and easily removed device to accommodate the passage of cords, tubes, hoses and the like through window openings and door openings while preventing undesired passage of air and water through the opening, and without compromising security.

### SUMMARY OF THE INVENTION

The present invention provides, in preferred and alternative embodiments, a device that may be easily installed in window openings and door openings, with a sealing pass-through opening through the device for the passage of an electrical cord or the like. A sealing means disposed in the opening through the device of the invention provides an effective barrier against the passage of air and/or water through the opening both with and without a cord extending through the opening and the sealing means.

The device of the invention includes a generally rectangular, generally planar body of either single pane or double pane construction. The body is preferably formed of a somewhat flexible but shape retentive material such as acrylic or polycarbonate, and is surrounded by a perimeter frame preferably formed of a resilient material. A pass-through aperture penetrates the body for extension of a cord or other object through the aperture, and seal assembly is provided in association with the aperture to maintain a seal against passage or air and water both with and without an object extending through the aperture.

In the preferred embodiment the seal assembly includes brush seals and web seals. Each brush seal includes two brushes, connected to the body on opposite sides of the aperture with bristles extending across the aperture. The bristles are deformable to allow the extension of an object through them, but sufficiently stiff to close against the object. Each web seal includes a flexible web connected to the body across the aperture, with one or more slits formed in the web. When an object is extended through the slit the web closes around the object.

When the device of the invention is installed in a sliding window or door, the perimeter frame is received in the channels in the window or door frame in which the window or door slides, and the window or door is closed against the device, securing it in place and forming a seal between the perimeter frame and the window or door structure. The device of the invention may also be permanently installed in a wall or eave of a structure, as non-limiting examples.

The structure and features of preferred and alternative embodiments of the device, and of variations within those embodiments, will be described in detail below, with reference to the accompanying drawing figures.

### BRIEF DESCRIPTION OF THE DRAWINGS

FIG. 1 is a front perspective view of a preferred embodiment of the device of the invention.

FIG. 2 is a front elevation view of the device of the invention installed in a double hung window.

FIG. 3 is a front elevation view of an unframed pane component of the device of the invention, with a pass-through aperture therein.

FIG. 4 is a side elevation view of a single pane component of the device of the invention.

FIG. 5 is a side elevation view of a double pane component of the device of the invention.

FIG. 6 is an end view of a perimeter frame component for use with a single pane embodiment of the device of the invention.

FIG. 7 is an end view of a perimeter frame component for use with a double pane embodiment of the device of the invention.

FIG. 8 is an end view of an alternative perimeter frame component for use with a double pane embodiment of the device of the invention.

FIG. 9 is a sectioned and partially cut-away side elevation view of the preferred embodiment of the seal assembly component of the device of the invention, along line 9-9 of FIG. 10.

FIG. 10 is a partially cut-away front elevation view of the preferred embodiment of the seal assembly component of the device of the invention.

FIG. 11 is a sectioned and partially cut-away side elevation view of an alternative embodiment of the seal assembly component of the device of the invention, from the same viewpoint as in FIG. 9.

FIG. 12 is a sectioned and partially cut-away side elevation view of another alternative embodiment of the seal assembly component of the device of the invention, from the same viewpoint as in FIG. 9.

FIG. 13 is a sectioned and partially cut-away side elevation view of a further alternative embodiment of the seal assembly component of the device of the invention, from the same viewpoint as in FIG. 9.

FIG. 14 is a sectioned and partially cut-away side elevation view of an additional alternative embodiment of the seal assembly component of the device of the invention, from the same viewpoint as in FIG. 9.

FIG. 15 is a partially cut-away front elevation view of the device of the invention, with a seal assembly, showing one type of closure door for the seal assembly.

FIG. 16 is a sectioned and partially cut-away side elevation view of the device of the invention, with seal assembly as in FIG. 15, along line 16-16 of FIG. 15.

FIG. 17 is a partially cut-away front elevation view of the device of the invention, with a seal assembly, showing another type of closure door for the seal assembly.

FIG. 18 is a partially cut-away front elevation view of the device of the invention, with a seal assembly, showing a variation of the type of closure door shown in FIG. 15.

FIG. 19 is a partially cut-away front elevation view of the device of the invention, with a seal assembly, showing a variation of the type of closure door shown in FIG. 17.

FIG. 20 is a front elevation view of an alternative embodiment of the device of the invention, with a screen panel and an alternative embodiment of the perimeter frame component.

FIG. 21 is a front elevation view of a variation of the alternative embodiment of FIG. 20, with sliding closure panes.

FIG. 22 is a front elevation view of the device of the invention installed in a sliding door opening (the sliding door partially shown), showing latches between the door and the device and between the device and the door frame.

FIG. 23 is a front elevation view of an alternative embodiment of the device of the invention, in which the body of the device is adjustable in length.

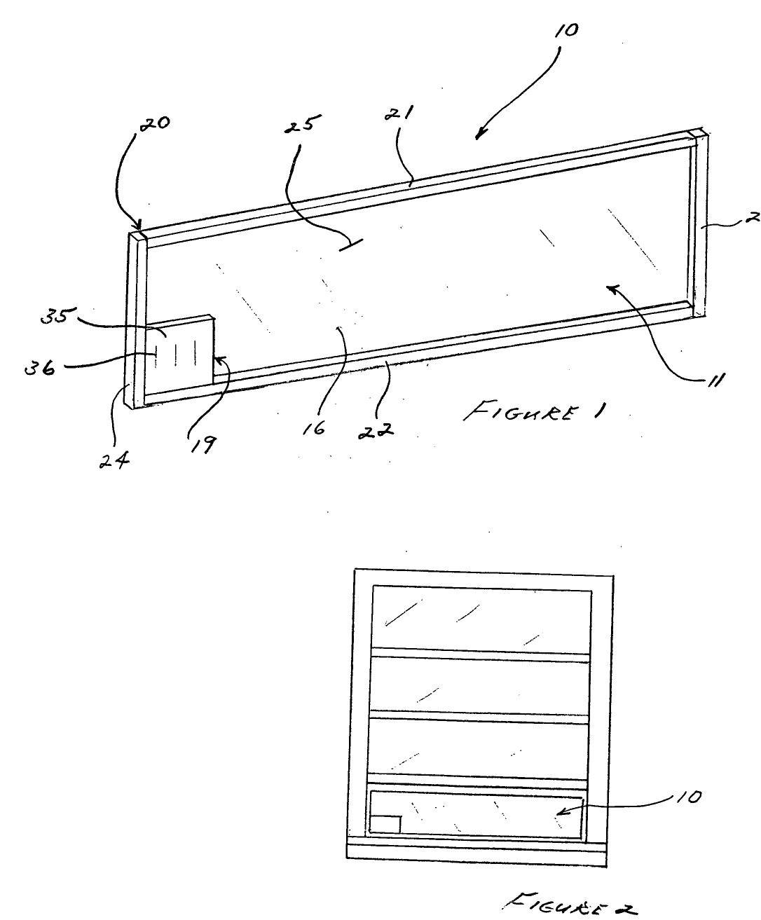

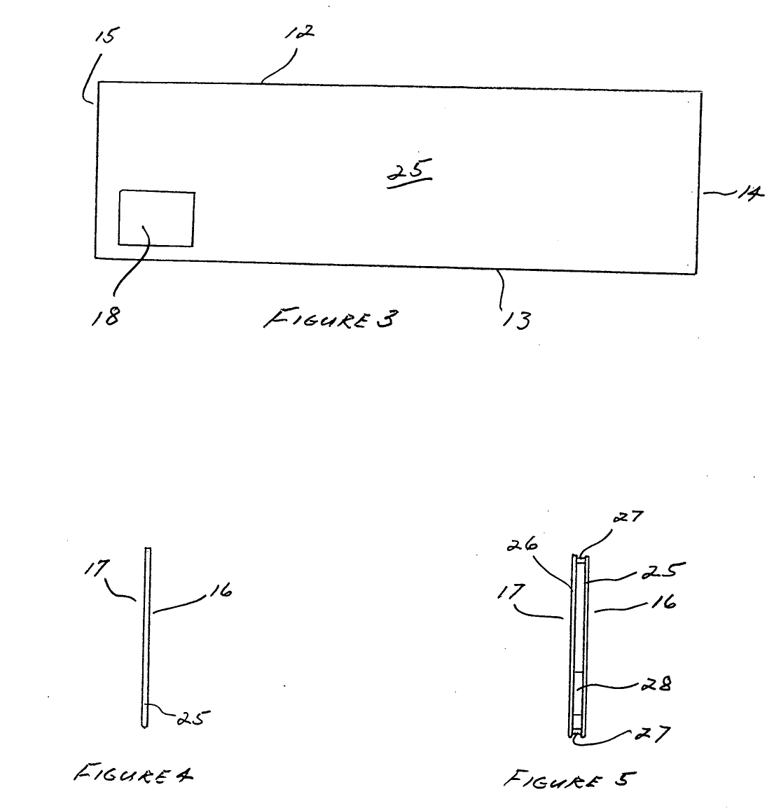

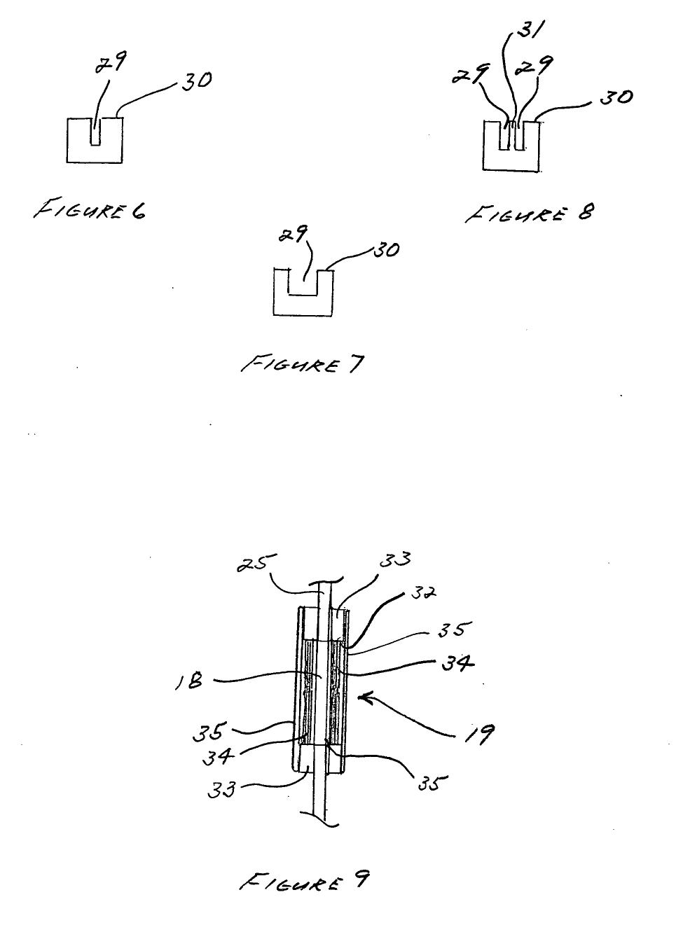

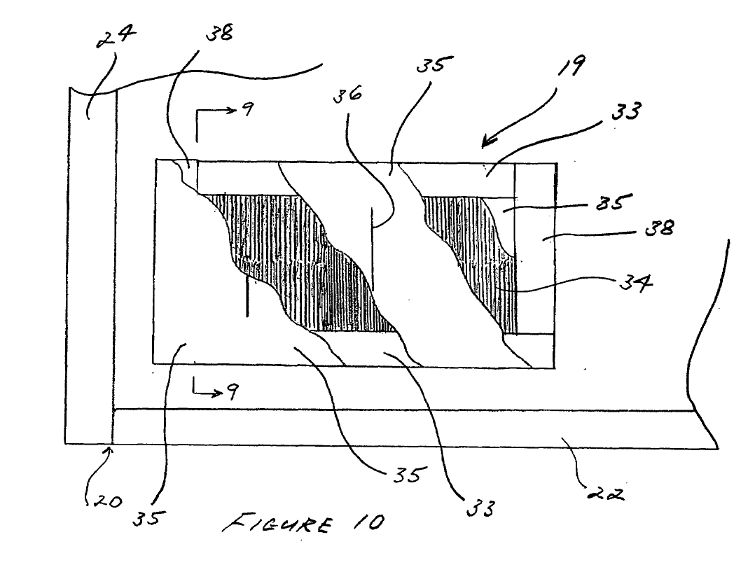

### DESCRIPTION OF THE INVENTION

In its preferred embodiments, the device of the invention, generally identified by reference number 10, includes a generally rectangular body 11 with opposed long edges 12 and 13, opposed short edges or ends 14 and 15, an inner face 16, and an outer face 17. Body 11 is penetrated by at least one pass-through aperture 18 for the passage of a cord or the like. A pass-through seal assembly 19 is connected to body 11 around and over aperture 18. Body 11 preferably also includes a perimeter frame 20, including long frame members 21 and 22, connected to long edges 12 and 13 of body 11, and short frame members 23 and 24, connected to short edges 14 and 15 of body 11.

In preferred embodiments of the device of the invention body 11 includes at least one panel or pane 25, preferably formed of a transparent, relatively rigid plastic material such as acrylic or polycarbonate. In one embodiment body 11 includes a single panel or pane, 25, and in another embodiment body 11 also includes a second panel or pane, 26, disposed parallel to pane 25 with an insulating space between them. In the double pane embodiment panes 25 and 26 may be separated by edge spacer 27 extending around the perimeter of and between the panes. In the double pane embodiment aperture 18 extends through both panes 25 and 26, and is preferably surrounded by spacer 28 to isolate the aperture from the insulating space between the two panes. It is preferred that spacer 28 be formed as a single length of material extending fully around the perimeter of the panes 25 and 26, but spacer 28 may also be formed of separate pieces, each extending, e.g., along one of the perimeter edges.

Frame 20 is preferably formed of a resilient material such as rubber or a resilient plastic. In the single pane embodiment of body 11, frame members 21, 22, 23, and 24 include a groove 29 extending longitudinally along the inner face 30 of each frame member, to receive a respective one of edges 12, 13, 14, and 15 of the single pane of body 11 during connection of the perimeter frame to the pane to form the body of the device. Frame 20 is preferably connected to the pane (or panes) by a suitable adhesive compound, although other means of connection could be used if desired. In the double pane embodiment the width of groove 29 is increased to accommodate the increased thickness of body 11 produced by the inclusion of panes 25 and 26 and spacer 27. In a variation or alternative embodiment of the double pane structure, two parallel grooves 29 are formed in the frame members, separated by an projection 31 that is received between panes 25 and 26 in lieu of spacer 27, which is omitted since the projection serves to maintain separation between the panes.

Pass-through seal assembly 19 serves to close aperture 18 against the movement of air and the ingress of water through the aperture, both with and without a cord or the like extended through the aperture. In the preferred embodiment seal assembly 19 includes two types of sealing means; a brush seal and a web or membrane seal. Each brush seal preferably includes a pair of brushes 32 connected in opposed parallel relation on either side of aperture 18 and on the same face of body 11. Each brush 32 includes a base 33 and a plurality of bristles 34, each connected at one end to base 33 and extending outwardly therefrom in closely spaced relationship. Bristles 34 are sufficiently flexible to allow the bristles to be displaced laterally, but sufficiently stiff and shape retentive to establish a bias toward their rest positions relative to base 33.

Base 33 of each brush 32 of each pair or set of brushes is connected to body 11 on opposite sides of aperture 18 so that bristles 34 of each brush extend across aperture 18 to meet bristles 34 of the opposite brush. When an object, such as an electrical cord, is pressed against bristles 34 at, e.g., the intersections of the bristles of the two brushes 32, bristles 34 will be displaced only enough to allow the object to pass through them and through aperture 18, and will seek to close against the protruding object.

Each web or membrane seal includes a web 35 formed of a tough, thin, flexible, elastic material, such as but not limited to a rubber material or a rubber-like plastic material, generally impermeable to the passage of air and water therethrough. Web 35 is connected to extend across and fully cover aperture 18. Web 35 is penetrated by at least one, and preferably several, slits 36 to receive and form a seal around an object such as an electrical cord that is extended through aperture 18. The elastic material of web 35 will expand and spread when an object is pressed against the web at a slit 36, opening the slit and allowing the object to extend through the web. Slit 36 will then close around the object to form a seal.

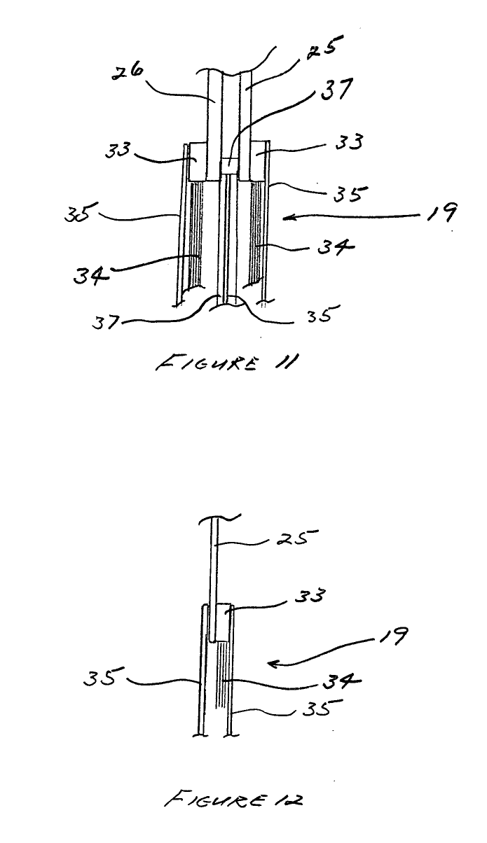

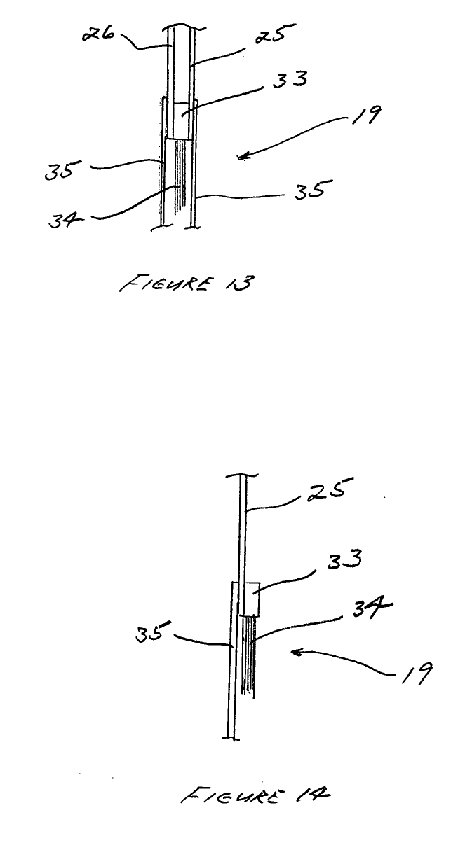

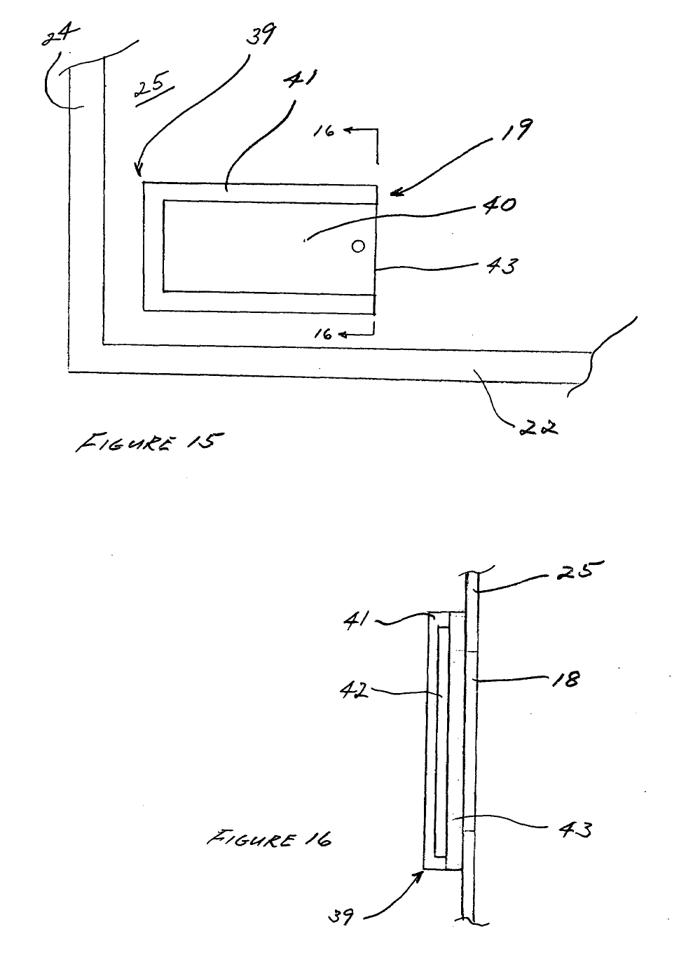

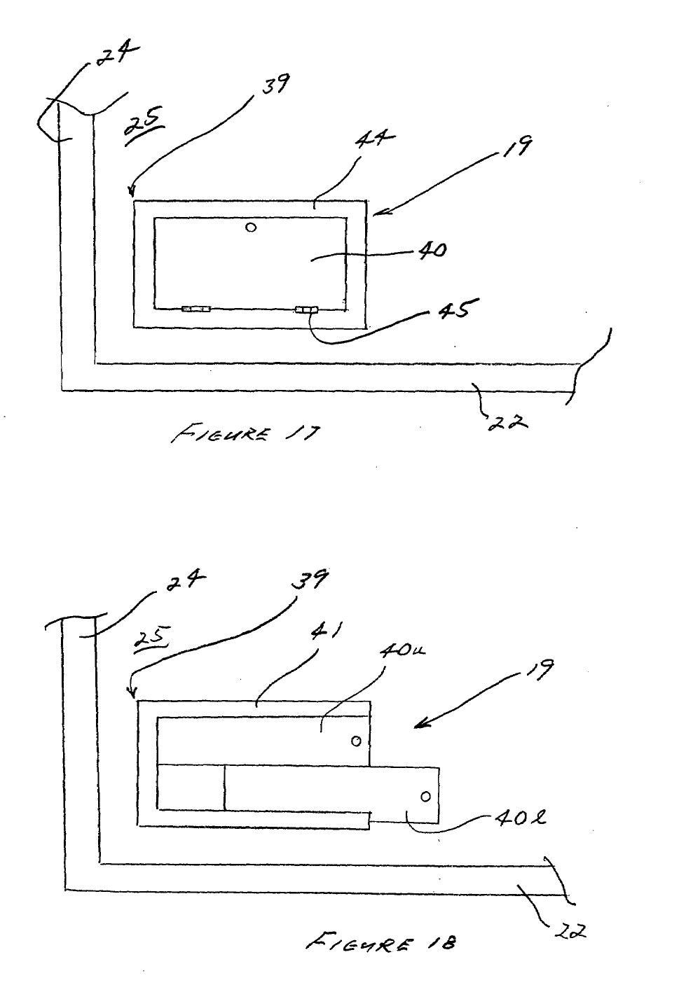

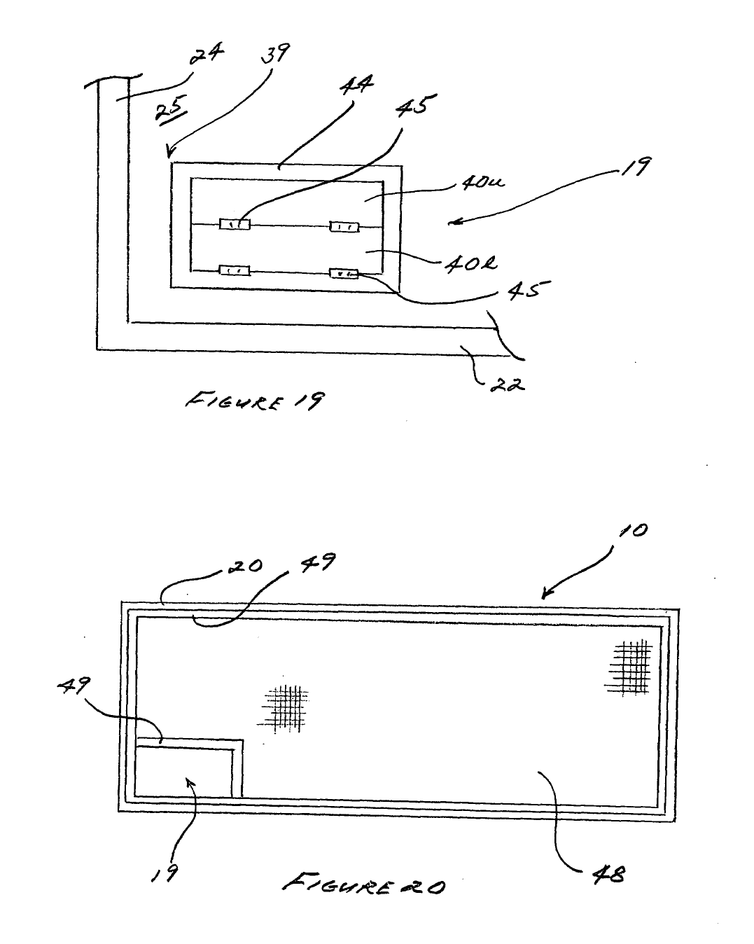

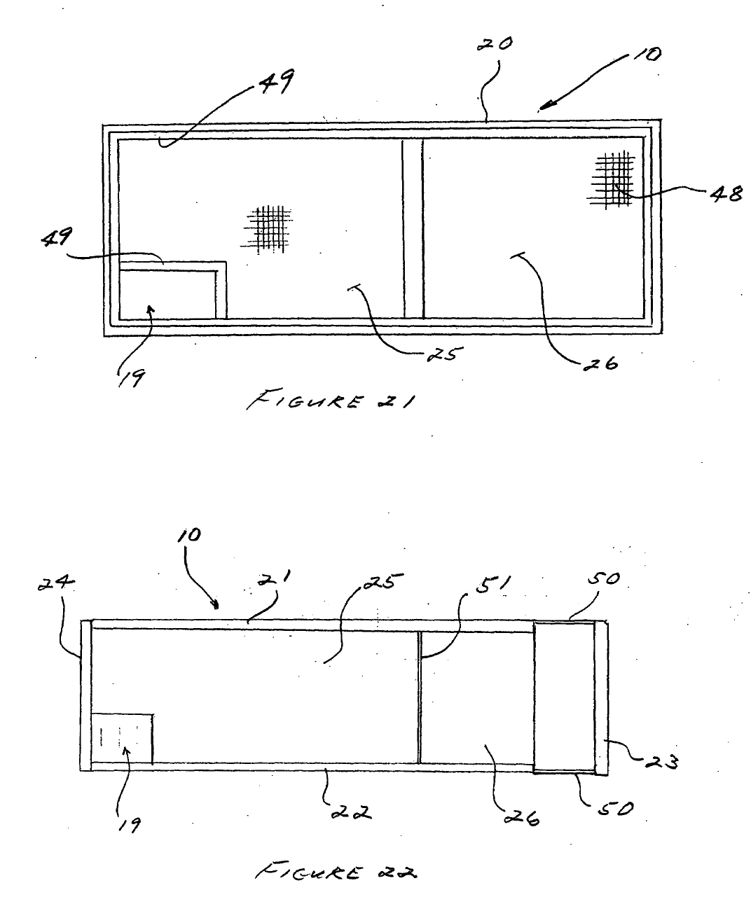

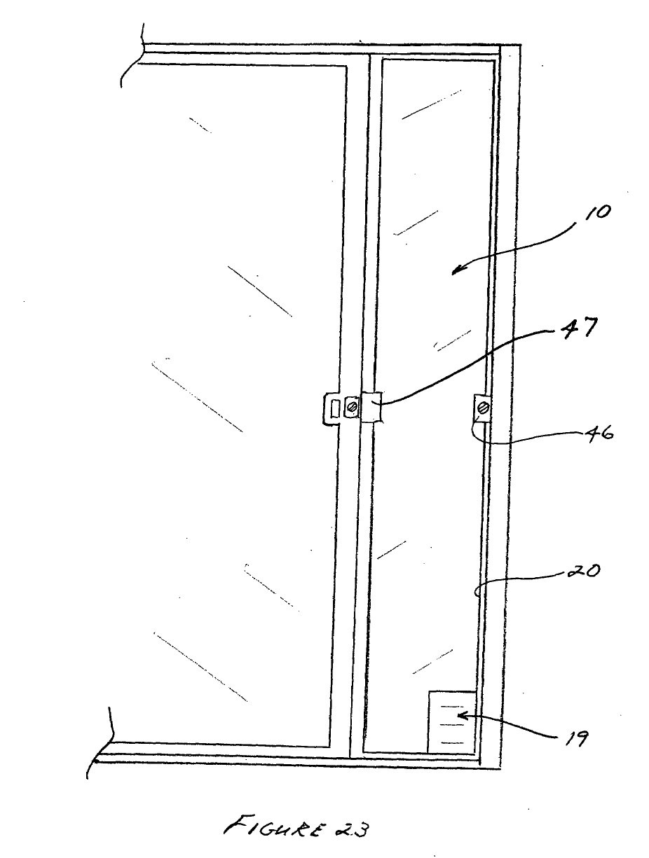

In the preferred embodiment of the device of the invention, seal assembly 19 includes three web seals and two brush seals, as shown in FIGS. 9, 10, and 11, disposed in an alternating relationship. In this embodiment a center web 35 is connected to, e.g., pane 25 across aperture 18 using a suitable adhesive, or, alternatively, is mounted in a surrounding frame 37 which extends around the edges of aperture 18. In the double pane embodiment, frame 37 may be disposed between panes 25 and 26, either in addition to or in lieu of spacer 28. A first, inner set of brushes 32 is connected to inner face 16 of body 11 with bristles 34 extending across aperture 18 parallel to the center web 35. A second, outer set of brushes is connected to outer face 17 of body 11 in a similar manner, with bristles 34 extending across aperture 18 on the opposite side of the body, parallel to the center web 35. An inner web 35 is connected to bases 33 of the inner set of brushes 32 connected to inner face 16 of body 11 to extend parallel to center web 35 and bristles 34 of the brushes. Similarly, an outer web 35 is connected to bases 33 of the outer set of brushes 32 connected to outer face 17 of body 11. In order to provide a base for the attachment of the edges of inner and outer webs 35 that are not connected to a base 33 of a brush 32, web connector members 38 are disposed between the ends of the bases of brushes 33 of each set and connected to the inner and outer faces of body 11 respectively. Web connector members 38 extend outwardly from the face of body 11 to which they are attached a distance equal to the distance of outward extension of bases 33. The edges of inner and outer webs 35 not connected to a base 33 is connected to the underlying web connector member 38, to fully secure inner and outer webs 35 to body 11. The plurality of web seals and brush seals used in this preferred embodiment of seal assembly 19 assures that aperture 18 will fully and securely sealed both with and without a cord or other object extending through the seal assembly and the aperture, providing a secure closure against the movement of air and water through aperture 18.

It is to be understood that although the embodiment of seal assembly 19 described above is preferred, other structures may be used within the scope of the invention. As one example, inner and outer webs 35, along with web connector members 38, may be omitted to provide a seal assembly 19 with a single, central web 35 and a set of brushes 32 on each face of body 11. In another example, a single pair of brushes 32 may be centrally disposed in or next to aperture 18, with an inner web 35 and an outer web 35 on the inner and outer faces of body 11. If brushes 32 are disposed between panes 25 and 26 in the double pane embodiment of body 11, the bases 33 of those brushes replace portions of spacer 28, and the remaining portions of spacer 28 extend between bases 33 to close the space between panes around aperture 18. As yet another example, a single web 35 and a single set of brushes 32 may be used. In this variation the brush seal may be disposed on the inner face of the body and the web seal disposed on the outer face, or vice versa.

In order to assure the secure closure of aperture 18 without a cord or other object extending through it, seal assembly 19 also preferably includes a door assembly 39 connected to, preferably, inner face 16 of body 11 around aperture 18. A sliding door embodiment of the door assembly includes a planar door panel 40 and a frame 41 within which door panel 40 is received in sliding relationship. Frame 41 may be formed as a generally U-shaped member, with grooves 42 to receive three of the four edges of door panel 40. Frame 41 is connected around aperture 18 and is preferably disposed outwardly of the brush seal(s) and web seal(s) of seal assembly 19, so that door panel 40 fully covers the brush and web seal(s). In order to provide a closure at the fourth edge of door panel 40 when the door panel is closed, a spacer block 43 is connected across the ends of frame 41. The distance of outward extension of spacer block 43 from the face of body 11 is less than the distance of extension of frame 41, so that spacer block 43 lies between door panel 40 and the adjacent face of body 11. If desired, a latch may be provided to secure door panel 40 in a closed position.

In another embodiment, door 40 is pivotally connected to body 11. In this embodiment a frame 44 is connected to body 11, extending fully around aperture 18, and door panel 40 is connected to frame 44 by hinge(s) 45. As noted above, a latch may be provided to secure door panel 40 in a closed position.

In a variation of the structures described above, door panel 40 may be divided into an upper panel 40u and a lower panel 401, in either the sliding door embodiment or the hinged door embodiment. In this variation the upper and lower door panels may be opened and closed independently of each other, so that the upper door panel may be opened for passage of a cord or other object, and the lower panel left closed to provide a support for the cord or other object. Supporting, e.g., a cord in this matter eliminates downward force imposed on the brush seal and/or web seal by the weight of the cord and facilitates formation of a secure seal around the cord.

The device of the invention may be easily installed in a sliding window or sliding door, and easily removed when not needed. The device is intended primarily for use in double-hung windows, in which framed glazing panels are moveable up and down within channels disposed at the sides of the window; side to side sliding windows, in which framed glazing panels are moveable side to side within channels disposed at the top and bottom of the window; and sliding doors, similar in structure to side to side sliding windows but larger in size. Each of these structures has at least two parallel channels in which a moveable portion of the window or door structure is slidably deposed, and which serve to retain the moveable portion within the window or door frame. The windows and doors installed in most buildings are factory fabricated in standard sizes, with uniform dimensions between parallel channels in all windows or doors of each standard size. It is contemplated that the device of the invention will be provided in a variety of lengths between short edges 14 and 15, with each length to fit a selected window or door size.

To install an appropriately sized unit of the device of the invention in a double hung window with vertically movable glazing panels, the glazing panel is moved in the channels to create an opening of greater height than the length of short frame members 23 and 24 of the device. One of the short frame members of perimeter frame 20, e.g., member 23, is inserted into one of the side channels of the window frame, with inner face 16 of body 11 facing inward of the window opening. Sufficient force is applied to member 24 and body 11 to create a slight bow in body 11 and long frame members 21 and 22 sufficient to allow frame member 24 to be inserted into the opposite channel of the window frame. The preferred materials of construction of body 11 and frame 20 are sufficiently flexible to allow a slight bow for insertion of frame member 24 in the window channel and then return to their original configuration. The flexibility of the members of frame 20 also facilitates the formation of a seal between frame members 23 and 24 and the channels in which they are disposed, while still allowing the device to be moved along those channels if needed for adjustment. Once frame members 23 and 24 are seated in the window frame channels, the device is moved along those channels as necessary to bring either frame member 21 or 22 into sealing contact with the window frame, and into a channel in the frame if the window construction includes such a channel, or against the sill of the window if a channel is not provided. The window is then closed against the remaining long frame member.

The manner of installation of a device of the invention in a side to side sliding window or in a sliding door is essentially the same as described above, except that the device is oriented vertically rather than horizontally. To remove the device from the window or door the installation steps are simply reversed. Installation requires no modification to the window or door structure, and the installed device does not interfere with the opening and closing of the window or door, allowing the window or door to be used for ventilation, and a door for ingress and egress.

The window or door in which the device is installed may also be secured against unauthorized opening. It is a common practice, for example, to secure a sliding door by placing a rod in the bottom channel in which the door sides. With the device of the invention installed, a shorter rod may be used to prevent the door from opening. The same approach can be used to secure windows. Alternatively, the latching means on a sliding door and the door frame may be replicated on the device of the invention, so that the device may be latched into the door frame with a latch component 46 and the door latched to a latch component 47 on the device when the door is closed.

The embodiments of the invention described above are intended to prevent the ingress and egress of air and water through the pass-through device. However, in some situations it is desirable to allow the movement of air through window and/or door openings, for purposes of ventilation, but not desirable to leave a window or door open to the entrance of insects, small animals, and the like, and/or to the exit of pets. To accommodate such situations the device of the invention may also be provided in a further alternative embodiment in which pane 25 or panes 25 and 26 are replaced by a screen panel 48, which will allow the movement of air through the panel but prevent the ingress and egress of, e.g., insects and animals. Unlike a semi-rigid pane such as pane 25, a screen panel does not provide structural stability, and in this embodiment the material of construction of perimeter frame 20 is sufficiently rigid to support the screen panel and maintain the configuration of body 11. In a variation, perimeter frame 20 may be formed with a semi-rigid structural frame component 49 to which more resilient frame members 21 through 24 are connected. It is also preferred that frame component 49 extend around aperture 18 in screen panel 48, to maintain the structural integrity around that aperture. Also with this embodiment the integrity of the seal formed by seal assembly 19 around a cord or other object is less significant, and the purpose of that seal is primarily to exclude insects and the like rather than preventing the passage of air and water. Accordingly, a seal assembly with one brush seal and one web seal will effectively accomplish that purpose, although it is to be understood that the scope of the invention is not limited to that form of seal assembly.

In a variation of the screen panel embodiment, panes 25 and 26 may be shortened to slightly more than half the length of long edges 12 and 13 of body 11 and disposed in perimeter frame 20 in sliding relationship, along with screen panel 48, to provide a sliding by-pass closure that can be partially opened or closed over screen panel 48. In this embodiment a perimeter frame with grooves 29 is used to support and guide panes 25 and 26, and frame component 49 is generally aligned with inner face 16 of the body of the device and extends only partially toward outer face 17 so as to avoid interference with grooves 29 and panes 25 and 26. At least one of panes 25 and 26 is movable within the associated groove 29 so that the movable pane(s) can be slid with the groove to open and close a ventilation passage through the screen panel. In another variation, a full length pane 25 may be connected to the perimeter frame by hinges to allow it to be opened and closed.

A by-pass sliding pane structure may also be used to provide an alternative embodiment in which the length of body 11, along long edges 12 and 13, is adjustable to accommodate variations in window or door opening dimensions. In this embodiment one pane, pane 25, preferably extends fully through the full collapsed, or shortest, length of the device, and a second pane, pane 26, preferably extends through less than the full length of the device, with the two panes in parallel, partially overlying relationship. Pane 26 preferably extends from one of the short edges of the body toward seal assembly 19, which is preferably positioned adjacent to the opposite short edge, but does not overlap seal assembly 19. In a variation, the length of pane 25 may be less than the full collapsed length of the device, so long as the length of pane 25 is sufficient to maintain an overlap between panes 25 and 26 when the device is fully extended.

In this embodiment perimeter frame 20 is modified from the structure used in the preferred embodiment, to allow the length of the long edges of the frame to be increased and decreased for adjustment of the fit of the device in, e.g., a window opening. In one approach, each of short frame members 23 and 24 is formed with a single groove 29, offset to opposite sides of the longitudinal axis of the frame member. Pane 25 is connected in groove 29 of frame member 24 at one end and abuts but is not connected to the non-grooved portion of frame member 23 at the opposite end with the body collapsed to its shortest length. Pane 26 is connected in groove 29 of frame member 23 at the opposite end of the body and extends toward frame member 24. Frame member 23 is not connected to the ends of long frame members 21 and 22. Long frame members 21 and 22 are preferably formed with double grooves 29, separated by extension 31. Pane 25 is preferably connected within the grooves 29 of the long frame members that are aligned with the offset groove 29 in short frame member 24, to secure pane 25 within the frame structure. Pane 26 is disposed in the other groove 29 of the long frame members, but not connected within the groove, so that pane 29 may be slid back and forth within those grooves. In this embodiment it is preferred that the components of perimeter frame 20 be rigid, since the frame need not be deformed during installation of the device in a window, in order to facilitate extension and contraction of the frame. It is preferred that the grooves in long frame members 21 and 22 to receive pane 26 be enlarged in comparison to the grooves to receive pane 25, and that the edges of pane 26 to be received in the associated groove be provided with a resilient edging strip 50. When the length of the body is extended and pane 26 is extended from the upper and lower long frame members, strip 50 will expand to seal within the window opening when the device is installed. To seal between panes 25 and 26, a resilient seal strip 51 is preferably connected along the end of pane 26 opposite the end connected to short frame member 23, to extend between pane 26 and pane 25 and close the gap between them. Variations in the structure of the perimeter frame and the connection of panes 25 and 26 thereto may be made within the scope of the invention, which is not limited to the structure described above.

The adjustable length alternative embodiment is installed in, e.g., a window opening by collapsing the device to a length shorter than the window opening, placed in position in the window opening, and then extended until short frame members 23 and 24 contact the window structure. The window is then closed against the adjacent long edge of the device to secure it in place within the window frame.

In another alternative embodiment, perimeter frame 20 may be omitted from the device of the invention, and body 11 permanently installed in, e.g., a window in replacement of an existing glazing panel or used in a newly constructed window or door in place of a glazing panel. A seal assembly 19 in accordance with the invention surrounded by a perimeter frame 20 may also be installed in a non-glazed opening formed in, e.g., a building wall or in an overhanging eave. In this embodiment pane 25 or panes 25 and 26, and the perimeter frame surrounding them, are omitted.

The foregoing description of preferred and alternative embodiments and of certain variations in those embodiments is intended to be illustrative and not limiting. The device is susceptible to further embodiments and variations within the scope of the invention, in accordance with the following claims.

1. A sealing device with integral self-sealing pass-through opening for closing an opening in a sliding window or door, allowing an object to be extended through the pass-through opening, and sealing around the object, comprising,
a body to be disposed in the window or door opening to close the opening, said body including a generally planar panel with an inner face and an outer face and a perimeter edge, said panel having a pass-through aperture formed in said panel between said inner face and said outer face, and a perimeter frame extending around said perimeter edge of said panel; and
a pass-through seal assembly including a brush seal having a first brush and a second brush, each of said brushes having a base and a plurality of bristles extending outwardly from said base, said base of said first brush connected to said panel adjacent to said aperture with said bristles of said first brush extending partially across said aperture, and said base of said second brush connected to said panel adjacent to said aperture in opposing relation to said base of said first brush, with said bristles of said second brush extending partially across said aperture toward said first brush to meet said bristles of said first brush, and further including a web seal formed of a thin, flexible web membrane connected over said aperture, said web having a slit formed therein for the extension of an object therethrough and between said bristles of said first and second brushes.

2. The sealing device of claim 1, wherein said first and second brushes are connected to said outer face of said panel of said body, and wherein said web is connected to said inner face of said panel of said body.

3. The sealing device of claim 1, wherein said first and second brushes are connected to said inner face of said panel, said pass-through seal assembly further includes a pair of web connector members connected in parallel relation to each other to said inner face of said panel between said bases of said first and second brushes on opposite sides of said aperture, and wherein said web is connected to said bases of said first and second brushes and to said web connector members on said inner face of said panel.

4. The sealing device of claim 2, wherein said web connected to said inner face of said panel is a first web, wherein said pass-through seal assembly further includes
a third brush and a fourth brush each having a base and a plurality of bristles extending outwardly therefrom, said third brush connected to said inner face of said panel with said base of said third brush parallel to said base of said first brush and with said bristles of said third brush extending parallel to said bristles of said first brush, and said fourth brush connected to said inner face of said panel with said base of said fourth brush parallel to said base of said second brush and with said bristles of said fourth brush extending parallel to said bristles of said second brush to meet said bristles of said third brush;
a first pair of web connector members connected in parallel relation to each other to said outer face of said panel between said bases of said first and second brushes on opposite sides of said aperture, and a second pair of web connector members connected in parallel relation to each other and to said first pair of web connector members to said inner face of said panel between said bases of said third and fourth brushes on opposite sides of said aperture;
a second web, having a slit formed therein, connected to said bases of said first and second brushes and to said web connector members of said first pair of web connector members in parallel relation to said outer face of said panel and separated therefrom by said first and second brushes and by said web connector members of said first pair, and a third web, having a slit formed therein, connected to said bases of said third and forth brushes and to said web connector members of said second pair of web connector members in parallel relation to said first web and separated therefrom by said third and fourth brushes and by said web connector members of said second pair.

5. The sealing device of claim 1, wherein said first and second brushes are connected to said inner face of said panel of said body, and wherein said web is connected to said outer face of said panel of said body.

6. The sealing device of claim 5, wherein said pass-through seal assembly further includes a second brush seal having a third brush and a fourth brush, each having a base and a plurality of bristles extending outwardly from said base, said base of said third brush connected to said outer face of said panel over said web in parallel relation to said base of said first brush with said bristles of said third brush extending partially across said aperture parallel to said bristles of said first brush, and said base of said fourth brush connected to said outer face of said panel over said web in opposed parallel relation to said base of said third brush with said bristles of said fourth brush extending partially across said aperture parallel to said bristles of said second brush to meet said bristles of said third brush.

7. The sealing device of claim 1, wherein said pass-through seal assembly further includes a door assembly having a door frame connected to said inner face of said panel around said aperture and outward on said panel of said brushes and said web, and a door panel movably connected to said door frame for selectively opening and closing said pass-through seal assembly.

8. The sealing device of claim 7, wherein said door frame includes a generally U-shaped frame member with an open end and with grooves formed therein, said grooves extending parallel to said panel of said body, and a spacer block connected to said panel of said body across said open end of said U-shaped frame member, and wherein said door panel is slidably received in said grooves and extends over said spacer block.

9. The sealing device of claim 8, wherein said door panel includes a first panel and a second panel each independently movable in said grooves of said U-shaped frame member.

10. The sealing device of claim 7, wherein said door panel is connected to said door frame by a hinge.

11. The sealing device of claim 10, wherein said door panel includes a first panel and a second panel, wherein said first panel is connected to said second panel by a hinge, and wherein said first panel is connected to said door frame by a hinge.

12. The sealing device of claim 1, wherein said panel is a single pane formed of a transparent material.

13. The sealing device of claim 1, wherein said panel includes a first pane and a second pane disposed in overlying, parallel, slightly separated relationship to each other within said perimeter frame.

14. The sealing device of claim 1, wherein said panel is formed of a screen mesh.

15. The sealing device of claim 1, wherein said body has a first end, a second end, and a length, wherein said panel includes a mesh screen connected within said perimeter frame, a first pane extending from said first end of said body toward said second end of said body through less than said length of said body in parallel relation to said mesh screen and fixedly connected within said perimeter frame, with said aperture formed in said first pane adjacent to said first end of said body, and a second pane with a length less than the distance between said aperture and said second end of said body, said second pane slidably disposed in said perimeter frame in partially overlapping parallel relation to said first pane, such that said second pane may be slid into contact with said perimeter frame at said second end of said body to close said body and may be slid toward said first end of said body to open a ventilation passageway through a portion of said mesh screen.

16. The sealing device of claim 1,
wherein said body has a first end, an opposing second end, a first edge and an opposing second edge and a length between said first and second ends, wherein said perimeter frame includes a first short frame member at said first end of said body, a second short frame member at said second end of said body, a first long frame member at said first edge of said body, and a second long frame member at said second edge of said body, each of said first and second long frame members having a first portion connected to said first short frame member and a second portion connected to said second frame member with said second portions of said long frame members being telescopically adjustable relative to the respective ones of said first portions of said long frame members, such that the length of said body is adjustable between a fully collapsed configuration and a fully extended configuration;
wherein said panel includes a first pane extending from said first end of said body toward said second end of said body through not more than said length of said body in said collapsed configuration and fixedly connected to said first short frame member and to said first portions of said first and second long frame members, with said aperture formed in said first pane adjacent to said first short frame member, and a second pane extending from said second end of said body toward said first end of said body in partially overlapping parallel relation to said first pane through a length not greater than the distance between said aperture and said second end of said body with said body in said collapsed configuration, said second pane fixedly connected to said second short frame member and to said second portions of said first and second long frame members.

17. A self-sealing pass-through device to be installed in an aperture extending through a structure, comprising,
a perimeter frame to be connected within the aperture, said frame defining and surrounding a pass-through opening; and
a pass-through seal assembly including a brush seal having a first brush and a second brush, each of said brushes having a base and a plurality of bristles extending outwardly from said base, said base of said first brush connected to said frame with said bristles of said first brush extending partially across said pass-through opening, and said base of said second brush connected to said frame in opposing relation to said base of said first brush, with said bristles of said second brush extending partially across said pass-through opening toward said first brush to meet said bristles of said first brush, and further including a web seal formed of a thin, flexible membranous web connected to said frame and extending fully over said pass-through opening in overlying relation to said brushes, said web having a slit formed therein for the extension of an object therethrough and between said bristles of said first and second brushes.

18. The self-sealing pass-through device of claim 17, wherein said web is a first web, and wherein said pass-through seal assembly further includes a second thin, flexible membranous web with a slit formed therein, said second web connected to said frame and extending fully over said pass-through opening, with said brushes disposed between said first web and said second web.

19. The self-sealing pass-through device of claim 17, wherein said brush seal is a first brush seal, and wherein said pass-through seal assembly further includes a second brush seal having a third brush and a fourth brush, each of said third and fourth brushes having a base and a plurality of bristles extending outwardly from said base, said base of said third brush connected to said frame with said bristles of said third brush extending partially across said pass-through opening, and said base of said fourth brush connected to said frame in opposing relation to said base of said third brush, with said bristles of said fourth brush extending partially across said pass-through opening toward said third brush to meet said bristles of said third brush, with said web disposed between said first brush seal and said second brush seal.

20. The self-sealing pass-through device of claim 19, wherein said web is a first web, and wherein said pass-through seal assembly further includes a second thin, flexible membranous web with a slit formed therein, said second web connected to said frame and extending fully over said pass-through opening, with said first brush seal disposed between said first web and said second web, and a third thin, flexible membranous web with a slit formed therein, said third web connected to said frame and extending fully over said pass-through opening, with said second brush seal disposed between said first web and said third web.
